(19) United States
(12) Patent Application Publication
(10) Pub. No.: US 2009/0182723 A1
(43) Pub. Date: Jul. 16, 2009

(54) RANKING SEARCH RESULTS USING AUTHOR EXTRACTION

(75) Inventors: Yauhen Shnitko, Redmond, WA (US); Dmitriy Meyerzon, Bellevue, WA (US); Hang Li, Beijing (CN); Yunhua Hu, Beijing (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/972,613

(22) Filed: Jan. 10, 2008

(51) Int. Cl. G06F 17/30

(52) U.S. Cl. 707/5; 707/E17.014

(57) ABSTRACT

Architecture that extracts author information from general documents and uses the author information for search results ranking. The architecture performs automatic author value extraction and makes the extracted value available at index time for subsequent use at query processing and results ranking. Machine learning (e.g., a perceptron algorithm) is employed and a set of input features for the perceptron algorithm utilized for author value extraction. The extracted author value is converted into a feature for input a ranking function for generating a ranking score for each document. The input features can also be weighted according to weighting criteria.

### BACKGROUND

The capability to store large amounts of information and then to make that information available serves as a catalyst for finding more efficient means for searching these vast stores of information. Metadata about information or documents (e.g., author, title, date of creation, and other properties) is important for a search engine. The document properties can be used by the search engine in multiple ways to improve the user experience. For example, properties can be used as query restrictions to limit the search results to only the documents that contain certain property values. Properties can be also used as ranking features to affect the ranking score of the document in the result set and displayed as part of the search results providing additional information to the user about the document.

Metadata is particularly useful for an enterprise search. Enterprise content is found in a greater variety of documents and typically is more structured content than available on the Internet. Moreover, enterprise systems maintain more document properties than Internet systems.

One interesting metadata property is the author of the document. The author property can be used in an advanced search as selection criteria, as a ranking feature to promote documents written by a person, and displayed in the results to make the result presentation more useful, if the author name or alias appears in the search keywords. Additionally, the author property can be used in creating expertise models based on collections of documents written by individuals and extracting the keywords from these collections for later matching and expertise analysis.

Unfortunately, the accuracy of the author metadata explicitly set on the documents is very low (e.g., more than half of all metadata values are inaccurate). Reasons for this include users forgetting to set metadata properties and the metadata is updated automatically by some systems that make the author property inconsistent with the true author. On the other hand the true author name is usually included in the document body and can be easily determined by a user looking at the document.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Described herein is architecture that extracts author information from general documents and uses the author information for search results ranking. The architecture solves a problem of dealing with inconsistent author metadata by performing automatic author value extraction and making the extracted value available at index time for subsequent use at query processing and results ranking.

The architecture employs machine learning (e.g., a perceptron algorithm) and a set of input features for the perceptron algorithm that is used for author value extraction. The extracted author value is converted into a feature for input a ranking function. The input features can be weighted according to the ranking model.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and equivalents. Other advantages and novel features will become apparent from the following detailed description when considered in conjunction with the drawings.

### BRIEF DESCRIPTION OF THE DRAWINGS

FIG. 1 illustrates a computer-implemented ranking system.

FIG. 2 illustrates a more detailed extraction system for extracting author information from a document.

FIG. 3 illustrates a perceptron model employed for author extraction.

FIG. 4 illustrates a metadata extraction model for extracting author information for document ranking.

FIG. 5 illustrates sections of the document for information retrieval searching.

FIG. 6 illustrates that the ranking component can include a ranking function that receives as input features related to author information.

FIG. 7 illustrates a system for processing search results using the author information to bias the search results.

FIG. 8 illustrates a computer-implemented method of ranking search results.

FIG. 9 illustrates a method of one example of an author extraction flow diagram using word processing document and a presentation document.

FIG. 10 illustrates an exemplary post-processing method for author extraction.

FIG. 11 illustrates a block diagram of a computing system operable to execute author extraction processing for search results ranking in accordance with the disclosed architecture.

### DETAILED DESCRIPTION

The disclosed architecture is a machine learning approach to author extraction from general documents. The extracted author information is then used for search results ranking. Rather than limited to dealing only with author metadata, which is inconsistent, automatic author value extraction is employed in the document as well, thereby improving the accuracy in the correct author information to be obtained.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

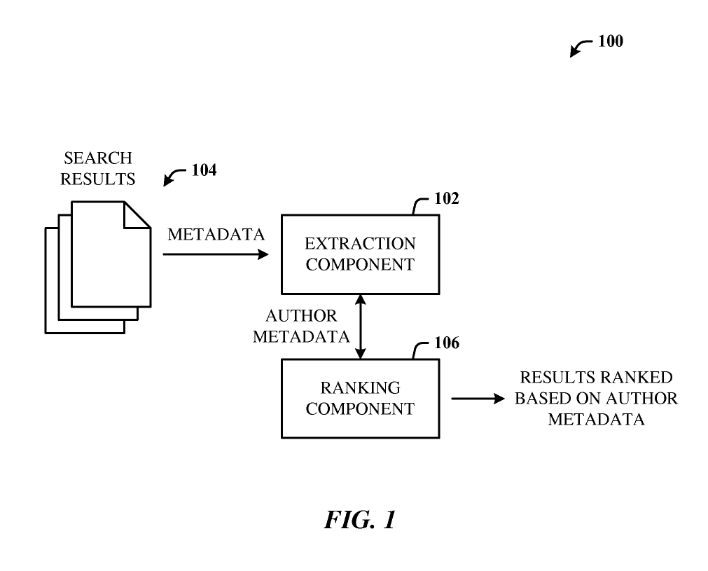

FIG. 1 illustrates a computer-implemented ranking system 100. The system 100 includes an extraction component 102 for extracting author metadata from documents 104 returned as results of a search. The system 100 also includes a ranking component 106 for ranking the documents 104 based in part on the author metadata. It is to be appreciated that the ranking component 106 can include other features in addition to author ranking.

The documents 104 include general documents, which include documents that belong to one of any number of specific genres. The documents 104 can be presentations, books, book chapters, technical papers, brochures, reports, memos, specifications, letters, announcements, and/or resumes, for example. General documents are more widely available in digital libraries, intranets, and the Internet. Document formats include, but are not limited to, HTML, XML, PDF, documents associated with word processors, spreadsheets, presentations, e-mail, rich media, database, and so on.

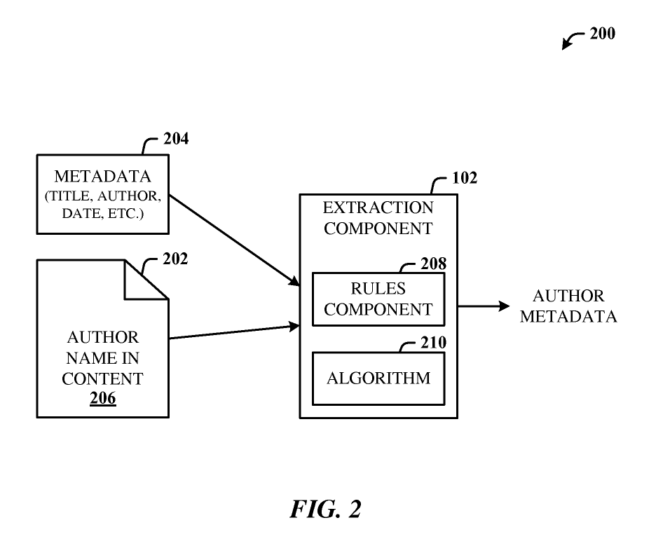

FIG. 2 illustrates a more detailed extraction system 200 for extracting author information from a document 202. The document 202 includes not only metadata 204 (e.g., titles, author, date, document size, etc.), but also document content 206. The document 202 can be a single page or multiple pages. In support of extracting the metadata 204 and for processing the document content 206, the extraction component 102 can include a rules component 208 and an algorithm 210.

The rules component 208 allows the specification of rules for guiding extraction of author information to specific areas (or units) of the documents. For example, in a multi-page presentation document, it is more likely that the author information would be on the first page. As a secondary consideration, a rule can be implemented such that extraction focuses on the last page for author information. Similarly, a rule can be created and implemented that focuses extraction below the title of a document, where an author name is typically presented. Combinations of rules can be executed to extract author information from document locations where the author information is more likely located. For example, a rule can be executed to focus extraction on the first page, and then a second rule to focus on information under or following the title of the first page, and a third rule for the content 206 of the first page of the document 202.

The algorithm 210 can be a machine learning algorithm that employs classification and model training. The subject architecture (e.g., in connection with selection) can employ various machine learning and reasoning MLR-based schemes for carrying out various aspects thereof. For example, a process for extracting specific information from large sets of information can be facilitated via an automatic classifier system and process.

A classifier is a function that maps an input attribute vector, x=(x₁, x₂, x₃, x₄, . . . , xₙ, where n is a positive integer), to a class label class(x). The classifier can also output a confidence that the input belongs to a class, that is, f(x)=confidence (class(x)). Such classification can employ a probabilistic and/or other statistical analysis to prognose or infer data that a user desires to be found. In the case of information processing, for example, attributes can be words, phrases or other data-specific attributes (also referred to as properties) derived from the information (e.g., documents), and the classes can be categories or areas of interest.

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, for example, various forms of statistical regression, naïve Bayes, Bayesian networks, decision trees, neural networks, fuzzy logic models, and other statistical classification models representing different patterns of independence can be employed. Classification as used herein also is inclusive of methods used to assign rank and/or priority.

As will be readily appreciated from the subject specification, the subject architecture can employ classifiers that are explicitly trained (e.g., via a generic training data) as well as implicitly trained (e.g., via observing user behavior, receiving extrinsic information). For example, SVM's can be configured via a learning or training phase within a classifier constructor and feature selection module. Thus, the classifier(s) can be employed to automatically learn and perform a number of functions according to predetermined criteria.

With respect to author extraction, author information can be annotated in sample documents (e.g., word processing documents, presentation documents, etc.) and the annotated documents utilized as training data to train several types of models. Author extraction can then be accomplished using any one of the trained models. In the models, textual characteristics, placement characteristics, etc., normally associated with author information can be employed. For example, formatting information such as font size, following title, author name versus non-name terms, etc., can be used as features. The algorithm 210 can employ models that include maximum entropy model, perceptron with uneven margins, maximum entropy Markov model, and voted perceptron. This description focuses on the perceptron algorithm.

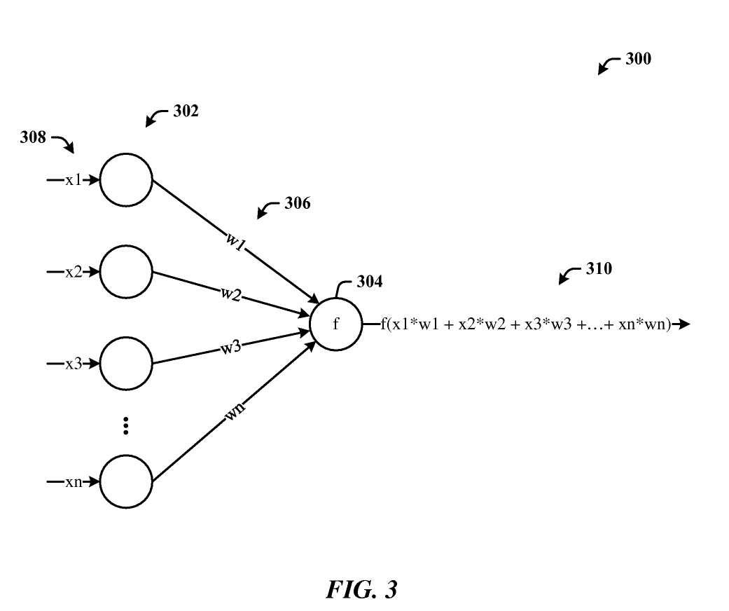

FIG. 3 illustrates a perceptron model 300 employed for author extraction. The author extraction classifier can be based on perceptron model (single layer neural network). Perceptron is a connected graph with several input nodes 302, one output node 304, weights 306 of links (w1, w2, w3, . . . wn) and an activation function (f). Input values (x1, x2, x3 . . . xn) 308, also called input features, given to the input nodes 302 at once are multiplied by the corresponding weights (w1, w2, w3, . . . wn). The sum of all the multiplied values is passed to activation function (f) to produce an output 310.

The input features that can be employed for author extraction include the following:

| Category | Feature | ID |
|---|---|---|
| Name list | If there are personal names that can be recognized by the help | 1 |
| | of name list in the unit, this feature will be 1; otherwise, 0. | |
| Uppercase | If the first letter of each word is not capitalized, this feature | 2 |
| | will be 1; otherwise, 0. | |
| Positive words | When the text of current unit begins with some words, such as | 3 |
| | “author:” and “owner:”, it will be 1; otherwise, 0. | |
| | When the text of current unit begins with some words, such as | 4 |
| | “speaker:” and “presented by”, it will be 1; otherwise, 0. | |
| | When the text of current unit contains some words, such as | 5 |
| | “author:” and “owner:”, it will be 1; otherwise, 0. | |
| Negative words | When the unit begins with some words, such as “To:” and | 6 |
| | “Copy to:”, it will be 1; otherwise, 0. | |
| | When the text of current unit begins with some words, such as | 7 |
| | “subject:” and “title:”, it will be 1; otherwise, 0. | |
| | When the text of current unit contains some words, such as | 8 |
| | “january”, it will be 1; otherwise, 0. | |
| Character count | If the number of characters in the unit is larger than 64 and is | 9 |
| | smaller than 128, this feature will be 1; otherwise, 0. | |
| | If the number of characters in the unit is larger than 128, this | 10 |
| | feature will be 1; otherwise, 0. | |
| Average word count | Average word number separated by comma. For example, if | 11 |
| | the unit is “Hang Li, Min Zhou”, the average word number of | |
| | this unit will be (2 + 2)/2 = 2. If the value is between 2 and 3, | |
| | this feature will be 1; otherwise, 0. | |
| | If the count is larger than 3, this feature will be 1; otherwise, 0. | 12 |
| Period mark | Personal names can contain “.”, e.g., “A. J. Mohr” and “John | 13 |
| | A. C. Kelly”. If the unit contains the pattern: capital + “.” + blank, | |
| | the feature of this category will be 1; otherwise, 0. | |
| End with Mark | If the text of current unit ends with “;”, “:” or “,”, and current | 14 |
| | unit did not begin with positive or negative words, this feature | |
| | will be 1; otherwise, 0. | |

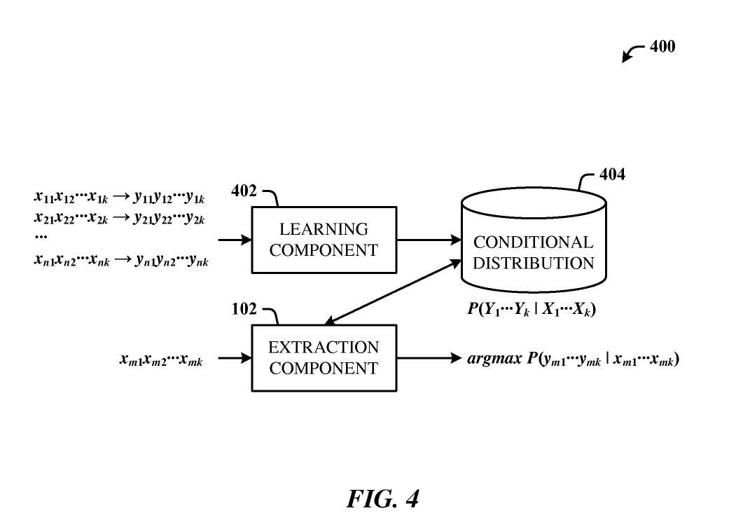

FIG. 4 illustrates a metadata extraction model 400 for extracting author information for document ranking. The models can be considered in the same metadata extraction framework. Thus, the models can be applied together. Each input to a learning component 402 (e.g., the perceptron algorithm 300) is a sequence of instances x₁x₂ . . . xₖ together with a sequence of labels y₁y₂ . . . yₖ, where xᵢ and yᵢ represent an instance and its label, respectively (i=1, 2, . . . k). An instance represents a unit. A label represents author_begin, author_end, or other annotation. Here, k is the number of units in a document.

In learning, a model is trained which can be generally denoted as a conditional probability distribution P(Y₁ . . . Yₖ|X₁ . . . Xₖ) 404, where Xᵢ and Yᵢ denote random variables taking instance xᵢ and label yᵢ as values, respectively (i=1, 2, . . . k).

Assumptions can be made about the general model in order to make it simple enough for training. For example, assume that Y₁, . . . , Yₖ are independent of each other given X₁, . . . , Xₖ. Thus,

P(Y₁ . . . Yₖ|X₁ . . . Xₖ)=P(Y₁|X₁) . . . P(Yₖ|Xₖ)

In this way, the model is decomposed into a number of classifiers. The classifiers can be trained locally using the labeled data. The classifier can be the perceptron or maximum entropy (ME) model. It can also be assumed that the first order Markov property holds for Y₁, . . . , Yₖ given X₁, . . . , Xₖ. Thus,

P(Y₁ . . . Yₖ|X₁ . . . Xₖ)=P(Y₁|X₁) . . . P(Yₖ|Yₖ₋₁|Xₖ)

Again, a number of classifiers can be obtained. However, the classifiers are conditioned on the previous label. When employing the perceptron or maximum entropy model as a classifier, the models become a perceptron Markov (PM) model or maximum entropy Markov (MEM) model, respectively. That is to say, the two models are more precise.

In extraction using the extraction component 102, given a new sequence of instances, one of the constructed models can be utilized to assign a sequence of labels to the sequence of instances (e.g., perform extraction). For perceptron and ME, labels are assigned locally and the results combined globally later using heuristics. For PM and MEM, a Viterbi algorithm can be employed to find the globally optimal label sequence. An improved variant of the perceptron, called Perceptron with uneven margin can also be employed. This version of perceptron works well especially when the number of positive instances and the number of negative instances differ greatly.

An improved version of perceptron Markov model can be employed in which the perceptron model is the commonly-known voted perceptron. In addition, in training, the parameters of the model are updated globally rather than locally.

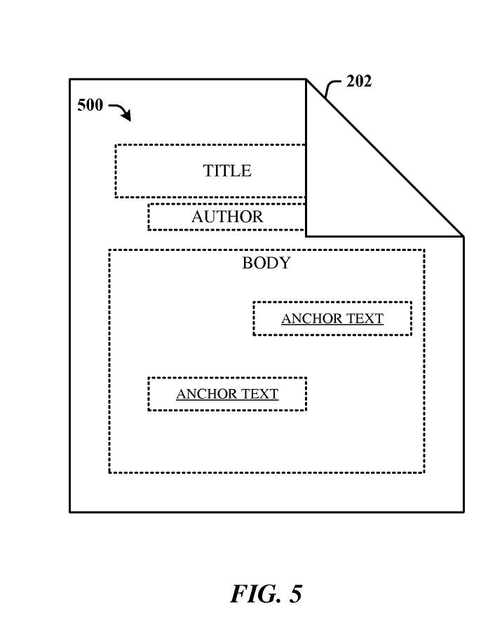

FIG. 5 illustrates sections 500 of the document 202 for information retrieval searching. Typically, in information retrieval a document is split into a number of fields, including body, title, author, and anchor text (e.g., link or clickable text). A ranking function in searching can use different weights for different fields of indicating that they are important for document retrieval. As previously described, a significant number of documents actually have incorrect author information in the file properties (metadata), and thus, in addition of using these properties, the extracted author information can be used as one more field of the document 202. Thus, overall precision is improved.

Author extraction based on machine learning and reasoning includes training and extraction. These pre-processing steps can occur before training and extraction. During pre-processing, for the top region of the first page of a document, a number of units for processing can be extracted. If a line (e.g., lines separated by ‘return’ symbols) only has a single format, then the line will become a unit. If a line has several parts and each part has its own format, then each part can become a unit. Each unit can be treated as an instance in learning. A unit contains not only current content information (e.g., linguistic information) but also formatting information. The input to pre-processing can be a document and the pre-processing output can be a sequence of units (instances). In learning, the input is the sequence of units where each unit corresponds to a document. In the case of author extraction, the individual unit is labeled with a complete author value. The author value can include multiple people names (e.g., co-authors).

In extraction, the input is a sequence of units from one document. One type of model that can be employed identifies whether a unit is a complete author value. Units can then be extracted from the classified units. The result is the extracted author of the document. In one implementation, formatting information is not employed. In an alternative implementation, formatting can be employed. A unique characteristic is the utilization of formatting information for author extraction. An assumption is that although general documents can vary in style, document formats have certain patterns and, the patterns can be learned and utilized for author extraction.

Following is exemplary unit text that can be derived during extraction pre-processing.

Unit1:

Unit2: [text=“Title: Operating System”, name_list=0, uppercase=0, positive_words=0, negative_words=1, character_count=0, average_word count=0, period_mark=0, end_with_mark=0]

Unit3:

Unit4:

Unit5: [text=Author: “John C. Doe”, name_list=1, uppercase=0, positive_words=1, negative_words=0, character_count=0, average_word count=0, period_mark=1, end_with_mark=0]

Unit6:

. . .

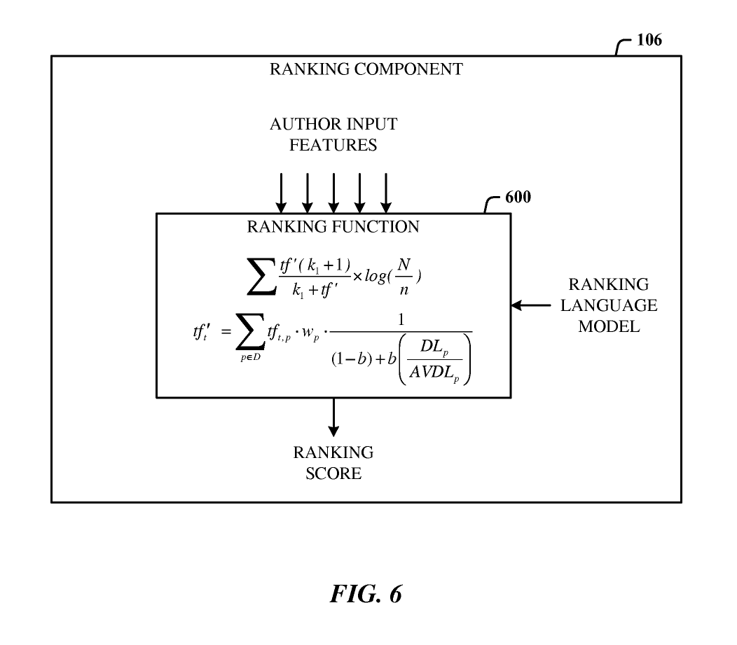

FIG. 6 illustrates that the ranking component 106 can include a ranking function 600 that receives as input features related to author information. The features are extracted during the indexing process and all the features are mapped to a single numerical ranking score. The features can be extracted from the document or the document metadata (e.g., term frequencies in the body of the document or in the metadata), or could be a result of more complicated analysis of the entire corpora with respect to the particular document (e.g., document frequency of the terms, aggregated anchor text, page rank, click distance, etc.). Generally, the ranking function 500 grows monotonically, with the expected probability of the document being relevant given a particular query.

Following is a ranking function (e.g., BM25, BM25F) that can be employed for applying field weighting when processing author information as input features. Fields such as body, title, extracted author, and anchor can be utilized. For each term in the query, the term frequency is counted in each field of the document. Each field frequency can then be weighted according to the corresponding weighting and length normalization parameters.

$$\sum \frac{{tf}^{ ′} ( {k}_{1} + 1 )}{{k}_{1} + {tf}^{ ′}} \times log ( \frac{N}{n} )$$

$${tf}_{t}^{ ′} = {\sum }_{p ∈ D} {tf}_{t , p} \cdot {w}_{p} \cdot \frac{1}{( 1 - b ) + b ( \frac{{DL}_{p}}{{AVDL}_{p}} )}$$

where, the tf_{t,p} is the term frequency for term t in property p, DLₚ is the length of property p, AVDLₚ is the average property length of document D, w is the property weight (a tunable parameter), k₁ is a tunable parameter, N is the number of documents in the corpora, b is a free parameter used for controlling document length normalization, and n is the number of documents containing the term (the document frequency). Extracted author information will be an additional property of the document with corresponding tf, DL, AVDL arguments and w, b parameters.

The ranking input features can depend on the query (e.g., term frequency tf of the query term in the document D), or be query independent (e.g., page rank, or in degree or document type). The query-dependent features are called dynamic, and are computed at query time. The query-independent features are static, and can be pre-computed at index time. It is also possible to pre-compute the combination of all static features given a ranking model to save computation costs. Dynamic rank features can also be incorporated into the ranking score using this function.

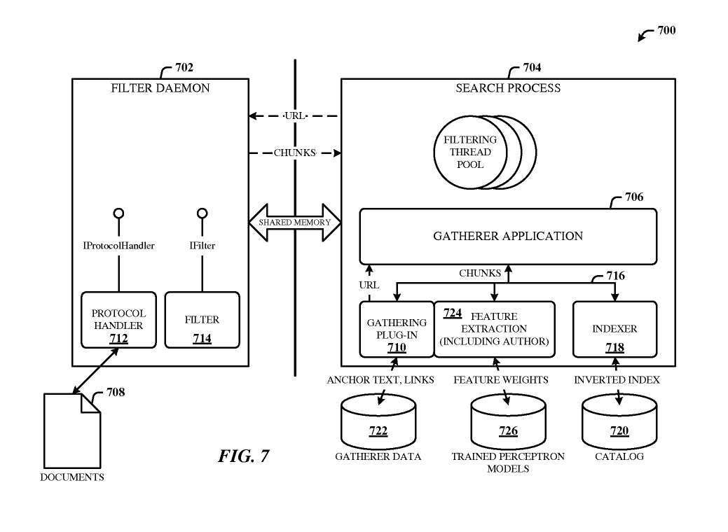

FIG. 7 illustrates a system 700 for processing search results using the author information to bias the search results. As illustrated, the system 700 includes a filter daemon 702 and a search process 704. The search process includes a gatherer application 706 that provides a generic mechanism for collecting searched-for items such as documents 708 from multiple stores, various formats, and languages. The documents 708 are searched via the filter daemon 702. The gatherer application 706 receives a URL from a gathering plug-in 710 and sends the URL to the filter daemon 702, which is processed though a protocol handler 712 and filter 714.

The gathering plug-in 710 can be one of several gatherer pipeline plug-ins. The gathering plug-in 710 identifies properties that are included in a document such as the text from the title or body, and the file type associated with the document. The properties are gathered by gathering plug-in 710 as the documents 708 are crawled. In one embodiment, the functionality of gathering plug-in 710 identifies all the fields of a document and the associated properties including the language type of the document.

The gatherer application 706 digests document content into a unified format suitable primarily for building a full text index over the documents. A gatherer pipeline 716 provides multiple consumers with access to gathered documents. The pipeline 716 is an illustrative representation of the gathering mechanism for obtaining the documents or records of the documents for indexing. The pipeline 716 allows for filtering of data by various plug-ins (e.g., gathering plug-in 710) before the records corresponding to the data are entered into an index by an indexer component 718. The indexer component 718 generates and stores data as an inverted index in a data catalog 720. The gatherer application 706 typically allows fetching the documents 708 once and processing the same data by multiple consumers.

The gathering plug-in 710 stores gatherer data such as anchor text, links, etc., in a gatherer datastore 722 (e.g., SQL database). For a particular document, the gatherer datastore 722 can include a record of the file type that is associated with the document. For example, a record may include a document ID that identifies the document and the file type in separate fields. In other embodiments, other fields may be included in the gatherer datastore 722 that are related to a particular document. A feature extraction plug-in 724 can also be employed to obtain feature weights from trained perceptron models 726.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

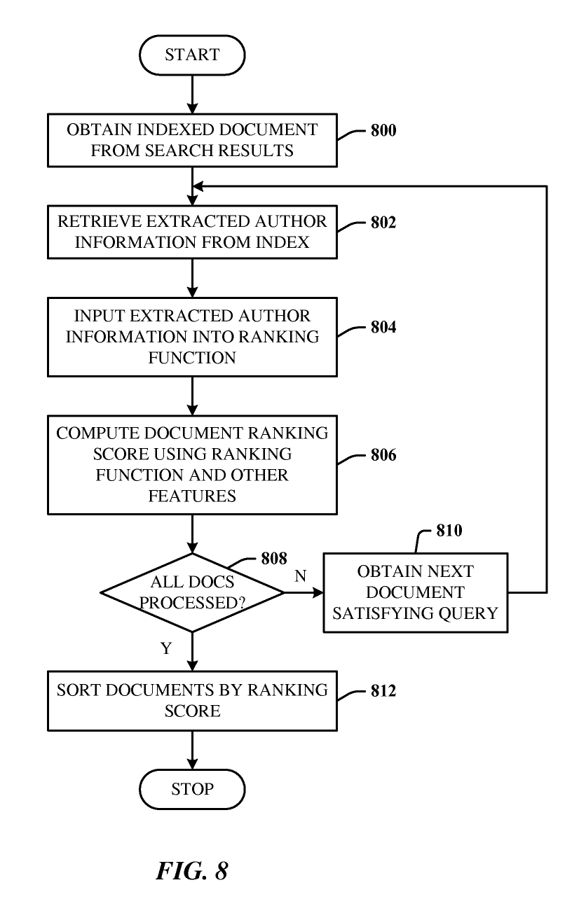

FIG. 8 illustrates a computer-implemented method of ranking search results. At 800, an indexed document is obtained from a set of search results that satisfy a search query. At 802, author information is extracted from the document index. At 804, the extracted author information is input into a ranking function. At 806, the document ranking score is computed using a ranking function and other features. At 808, a check is made to determine if all documents have been processed. If not, flow is to obtain the next document, and then back to 802 to continue processing. On the other hand, if all documents have been processed at 808, flow is to 812 to sort the documents by the ranking scores.

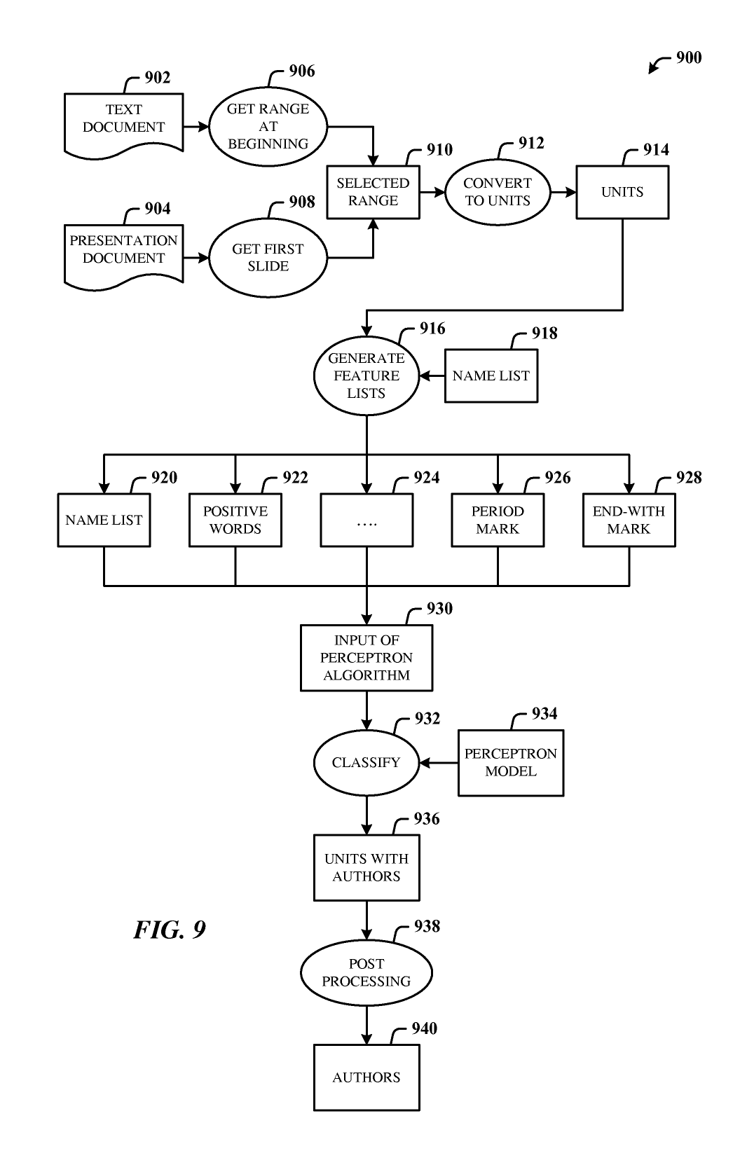

FIG. 9 illustrates a method of one example of an author extraction flow diagram 900 using word processing document 902 and a presentation document 904. At 906, the beginning range is obtained for the text document. At 908, the first slide is obtained from the presentation document 904. At 910, the selected range is obtained. At 912, the range is converted into a unit. At 914, the resulting units are used at 916 for the generation of feature lists. This includes receiving name lists 918. The features generated include the name list 920, positive words 922, other feature inputs 924 (e.g., negative words, character count, average word count), period mark 926, and end-with mark 928. The feature lists are then input to a perceptron algorithm at 930 for classification at 932. The classification process 932 uses a perceptron model 934 to output units with authors at 936. Post-processing then takes the units and outputs the author information.

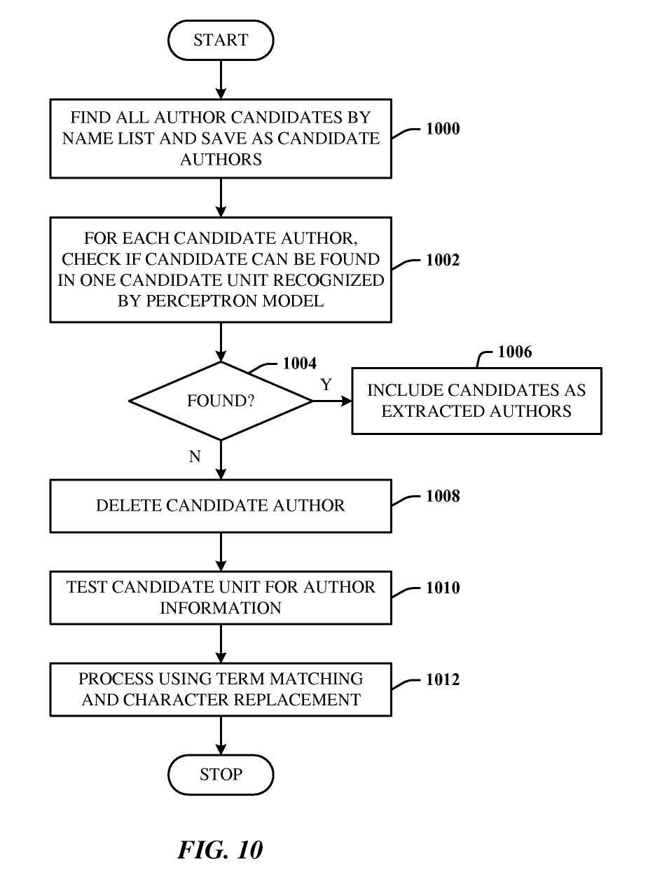

FIG. 10 illustrates an exemplary post-processing method for author extraction. At 1000, all author candidates are found by name list and save as candidate authors. At 1002, for each candidate author, check if candidate can be found in one candidate unit recognized by perceptron model. If found, at 1004, the candidates are included as extracted authors, at 1006. If not, at 1004, the candidate is deleted, at 1008. At 1010, the candidate unit that includes no candidate author is processed for author extraction using patterns. At 1012, the processing includes pattern matching and character replacement. The pattern can be as follows “ . . . ”+special word (“Author:”, “Owner:”, etc.)+“:”+“\t” (one or more)+author. Replace “(”, “)”, “/”, “-” and other special markup in the previous results with space, except “'” and “.”. Then replace continuous space with single space.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

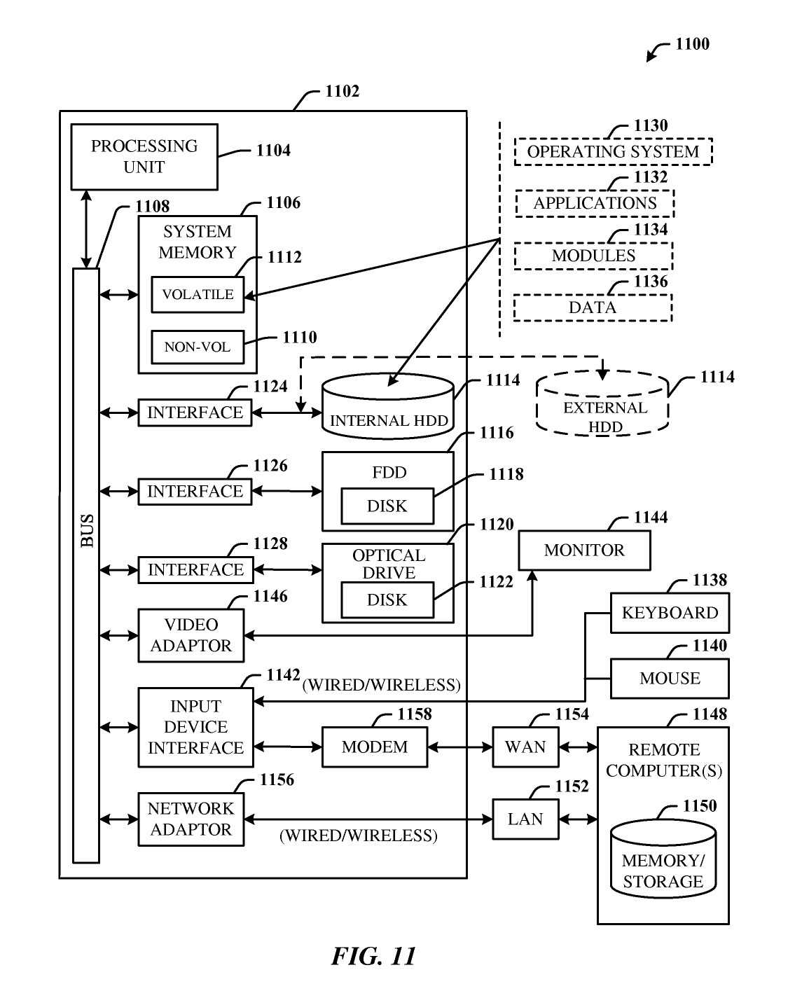

Referring now to FIG. 11, there is illustrated a block diagram of a computing system 1100 operable to execute author extraction processing for search results ranking in accordance with the disclosed architecture. In order to provide additional context for various aspects thereof, FIG. 11 and the following discussion are intended to provide a brief, general description of a suitable computing system 1100 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 11, the exemplary computing system 1100 for implementing various aspects includes a computer 1102 having a processing unit 1104, a system memory 1106 and a system bus 1108. The system bus 1108 provides an interface for system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 can include non-volatile memory (NON-VOL) 1110 and/or volatile memory 1112 (e.g., random access memory (RAM)). A basic input/output system (BIOS) can be stored in the non-volatile memory 1110 (e.g., ROM, EPROM, EEPROM, etc.), which BIOS stores the basic routines that help to transfer information between elements within the computer 1102, such as during start-up. The volatile memory 1112 can also include a high-speed RAM such as static RAM for caching data.

The computer 1102 further includes an internal hard disk drive (HDD) 1114 (e.g., EIDE, SATA), which internal HDD 1114 may also be configured for external use in a suitable chassis, a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as a DVD). The HDD 1114, FDD 1116 and optical disk drive 1120 can be connected to the system bus 1108 by a HDD interface 1124, an FDD interface 1126 and an optical drive interface 1128, respectively. The HDD interface 1124 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 1112, including an operating system 1130, one or more application programs 1132, other program modules 1134, and program data 1136. The one or more application programs 1132, other program modules 1134, and program data 1136 can include the extraction component 102, ranking component 106, search results 104, author metadata, ranked results, the document 202, metadata 204, document content 206, rules component 208, algorithm 210, perceptron algorithm 300, learning component 402, conditional distribution 404, document sections 500, ranking function 600, and system 700, for example.

All or portions of the operating system, applications, modules, and/or data can also be cached in the volatile memory 1112. It is to be appreciated that the disclosed architecture can be implemented with various commercially available operating systems or combinations of operating systems.

A user can enter commands and information into the computer 1102 through one or more wire/wireless input devices, for example, a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces such as a parallel port, IEEE 1394 serial port, a game port, a USB port, an IR interface, etc.

A monitor 1144 or other type of display device is also connected to the system bus 1108 via an interface, such as a video adaptor 1146. In addition to the monitor 1144, a computer typically includes other peripheral output devices (not shown), such as speakers, printers, etc.

The computer 1102 may operate in a networked environment using logical connections via wire and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wire/wireless connectivity to a local area network (LAN) 1152 and/or larger networks, for example, a wide area network (WAN) 1154. Such LAN and WAN networking environments are commonplace in offices and companies, and facilitate enterprise-wide computer networks, such as intranets, all of which may connect to a global communications network, for example, the Internet.

When used in a LAN networking environment, the computer 1102 is connected to the LAN 1152 through a wire and/or wireless communication network interface or adaptor 1156. The adaptor 1156 can facilitate wire and/or wireless communications to the LAN 1152, which may also include a wireless access point disposed thereon for communicating with the wireless functionality of the adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wire and/or wireless device, is connected to the system bus 1108 via the input device interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented ranking system, comprising:
an extraction component for extracting author information from documents returned as results of a search; and
a ranking component for ranking the documents based in part on the author information.

2. The system of claim 1, wherein the extracted author information is made available at index time for queries and ranking of the documents.

3. The system of claim 1, wherein the extracted author information is metadata associated with the documents.

4. The system of claim 1, wherein the extracted author information is obtained from content of the documents.

5. The system of claim 1, further comprising a machine learning algorithm for extracting the author information from the documents.

6. The system of claim 5, wherein the machine learning algorithm is based on a perceptron model.

7. The system of claim 6, wherein the perceptron model is an author extraction perceptron that employs input features which include one or more of author name, positive word, negative word, character count, average word count, period mark, or end-with mark.

8. The system of claim 1, further comprising a rules component for focusing extraction on a particular unit of the documents.

9. The system of claim 1, wherein the author information is an input feature to the ranking component, the ranking component based on a variant of a BM25 ranking function, the variant defined by:
$$\sum \frac{{tf}^{ ′} ( {k}_{1} + 1 )}{{k}_{1} + {tf}^{ ′}} \times log ( \frac{N}{n} )$$
$${tf}_{t}^{ ′} = {\sum }_{p ∈ D} {tf}_{t , p} \cdot {w}_{p} \cdot \frac{1}{( 1 - b ) + b ( \frac{{DL}_{p}}{{AVDL}_{p}} )}$$
where, the tf_{t,p} is a term frequency for term t in property p, DLₚ is a length of property p, AVDLₚ is an average property length of document D, w is a property weight, k₁ is a tunable parameter, N is the number of documents in a corpora, b is a free parameter for controlling document length normalization, and n is the number of documents containing the term t.

10. A computer-implemented ranking system, comprising:
an extraction component that employs a machine learning algorithm for extracting author information from a general document returned in results of a search; and
a ranking component for ranking the general document among the document results based on a ranking function that receives author-related input features to output a document score.

11. The system of claim 10, further comprising a rules component for focusing extraction to a unit of the document based on one or more rules.

12. The system of claim 10, wherein the author-related input features are weighted.

13. The system of claim 10, wherein the author information is extracted from the document body or the document metadata.

14. A computer-implemented method of ranking search results, comprising:
extracting author information from a document returned in results of a search;
inputting the author information into ranking function;
computing a document ranking score; and
ranking the document relative to the results based on the author information.

15. The method of claim 14, further comprising extracting the author information using a classifier based on a perceptron model.

16. The method of claim 15, further comprising finding author candidates for the author information using a name list as an input to the model.

17. The method of claim 14, further comprising testing for the author information in a candidate unit using characters patterns.

18. The method of claim 14, further comprising generating a feature list for input to a perceptron algorithm, the feature list includes one or more of a name list, positive words, negative words, period mark, character count, average word count, and end-with mark.

19. The method of claim 14, further comprising identifying units of the document that contain the author information using a classifier.

20. The method of claim 14, further comprising associating the author information with the document at index time.
